(19) United States
(12) Patent Application Publication
(10) Pub. No.: US 2006/0183838 A1
(43) Pub. Date: Aug. 17, 2006

(54) Synthetic binding agent for producing powder paints, powder paints containing this agent, and coats and coatings produced therewith

(76) Inventor: Gerhard Reich, Wels (AT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/542,688

(22) PCT Filed: Jan. 16, 2004
(86) PCT No.: PCT/AT04/00011

§ 371 Date: Jul. 19, 2005

(30) Foreign Application Priority Data
Jan. 24, 2003 (AT) A 97/2003

(51) Int. Cl. C08K 3/22

(52) U.S. Cl. 524/430; 524/493; 524/497

(57) ABSTRACT

The invention relates to a synthetic resin binder for producing powder paint that has admixed with it pyrogenic oxides of silicon, aluminum or titanium, preferably pyrogenic silicic acid, or mixtures thereof with primary particle sizes between 6 and 65 nm, powder paint containing same and coats and coating made therewith.

The invention relates to a synthetic binding agent [synthetic resins or plastic binders] for producing binder paints, binder paints containing the synthetic resin binder and to coats and coatings made with paints containing the binder.

Powder paints have long been recognized as highly desirable coating agents. Above all they omit solvents and thus are ecologically and economically highly desirable.

In present practice, synthetic resin binders which have the potential to undergo a subsequent hardening reaction upon the application of heat or radiation, can be intimately mixed with optional further materials like pigments, fillers and additives in finely divided form in an extruder under heat to a homogeneous plastic mass. This mass is cooled, broken up, milled and sieved and then constitutes a powder paint.

A special feature in the fabrication of powder paints in accordance with the extrusion process usually used is that the process is continuous and is thus distinguishable from earlier processes of the batch type also involving intimate dry mixing of premeasured amounts of material and which at this point manifests a discontinuity. The extrusion process, after the passage through the extruder provides an ideal through and through perfectly homogeneous mass.

The foregoing requirements for complete homogeneity which is desirable for the greatest possible economy of the process, thus is already available. However, with this state of the art it is unavoidable that many powder paint formulations, after a first extrusion for a variety of technological and/or aesthetic reasons, must be passed through an extruder a further time after corresponding precomminution of the first extruder product. The multiple extrusion requirement has not only economic drawbacks but technological disadvantages as well. There is a danger of unnoticed contamination of the powder paint mass by components along to the formulation which can only be recognized by the formulation of craters, this danger growing with the number of process steps which are required. In addition, with heat-hardenable formulations, there is a possibility of a partial or prereaction during the extrusion steps. Multiple extrusions can in such cases lead naturally to increased prereaction of the binder partners which, apart form making milling more difficult, can lead to a reduction in quality. Usually characteristics like the flow of the powder paint and its ability to wet the substrate are reduced. It is difficult in only a single extrusion step to provide powder paint masses which are technologically and aesthetically capable of making completely satisfactory powder paint. The system viscosity of the mixture in the extruder may be too low and hence it has been proposed to raise the system viscosity by employing finely divided fillers on the basis of the pyrogenic oxides of silicon and also aluminum or titanium with particle sizes well below the μm range.

Examples of the synthetic binders referred to herein are synthetic resins like polyester resins, poly(meth)acrylate resins, oxide resins or mixtures thereof and synthetic resin binders which are customarily known as hardeners like β-hydroxyalkylamide, trigli cydalisocyanates diglycidylterephthalate, triglycidyltrimellitate, isocyanate adducts or mixtures thereof. Amont the synthetic resin binders which are used to make powder paints, the class of polyesters plays a special role because of their exceptional properties and the broad range of applications which result therefrom.

Under the designation, “pyrogenic oxides”, highly dispersed oxides are collected which are produced by flame hydrolysis and as such are hydrophilic. Included as well are such versions which are subjected to a more or less encompassing supplemental chemical conversion of their surface hydroxyl groups with organosilicon compounds to provide a more or less pronounced hydrophobic character [surface treatment].

The greatest range of technological applications are found with pyrogenic silicic acid. More than the other pyrogenic oxides, it can be used in numerous different finenesses (average particle size of the different types from about 7 to about 40 nm) and as such is hydrophilic.

The incorporation of such pyrogenic oxides in powder paint formulations is state of the art and the pyrogenic oxides can be employed for a variety of reasons. Among others, the reduction of a general spalling tendency of the paint upon firing or the improvement of its covering properties of corners or edges can be mentioned. In addition, formulations with fillers having an especially pronounced amplification effect can be provided. These highly dispersable substances are worked into the dry mixture of the powder paint raw material with additives, albeit in small amounts and after the mixing process are incorporated in the mass in the subsequent extrusion.

Corresponding tests of powder paint formulations which have numerous craters following a single extrusion process with the addition of 0.75% Aerosil® 200 (highly dispersed pyrogenic silicic acid produced by flame hydrolysis over 99.8% SiO₂ content) show that the formulation of the powder paint with respect to the number of craters observed, can be significantly improved. On the other hand it was found that the surface of the powder paint had other defects: a slight crinkling which appeared to the eye primarily as a reduced shine or glossiness, as well as a noticeably poorer flow property. These drawbacks could be largely eliminated by a subsequent extrusion although the repeated extrusions have been indicated previously is not desirable.

The object of the invention is to make it possible to prepare a powder paint without technological or aesthetic drawbacks by means of a single extrusion step for the basic dry mixture.

The object is achieved in a surprising manner according to the intention in that the synthetic binding agent [synthetic resin binder] is treated or mixed with a pyrogenic oxide of silicon, aluminum or titanium or mixtures thereof, with primary particle sizes between 5 and 65 nm. Such a synthetic binder agent is then used for the production of a powder paint. The pyrogenic oxide or oxides added to the synthetic binder have, on the one hand, an aggregative or amplifying or thickening and strengthening effect for the synthetic binder and result in an increase in a viscosity of the binder. On the other hand the use of the synthetic binder in powder paint preparations with pyrogenic oxides, enables the pyrogenic oxides which have been added to the synthetic binder to have a substantially improved distribution in the finished powder paint and a better distribution than would have been the case had the pyrogenic oxides been added first in the dry mixture for forming the powder paint.

This effect is indeed surprising since manufacturers' requirements have indicated that the use of devices with high shear rates (high rotation speed dissolvers for example) are required for dispersing Aerosils® and as would be expected also aluminum oxide C and titanium oxide P in liquid media in order to so disperse these finely divided substances that their technological potential can be realized. For that reason in descriptions of the technological applications, details have been provided as to the configuration of the dissolver disks, their peripheral speeds, the mass temperature and the optional use of ultrasound (see for example: Technical Bulletin Aerosil® No. 54, Degussa A G, Frankfurt, German “Aerosil® for Unsaturated Polyester Resins and Vinyl Ester Resins”). It is also surprising since the half-moon stirrer of a laboratory apparatus for producing polyester resins in kilogram quantities with a speed of only about 60 to 100 revolutions per minute in tests with the addition of 1% Aerosil® quantities give rise to a better distribution in the final powder paint than the addition of an equivalent quantity in the manner described in the state of the art, not in accordance with the invention, namely directly in the crude mixture for producing powder paint. These facts will be appreciated from the following example.

Surprisingly, further, it has been found that a powder paint made from the synthetic resin according to the invention not only has significant advantages from the point of view of its appearance with respect to a conventionally produced powder paint but is also superior thereto from a technological viewpoint. The so-called water spot test (which is a component of the quality standards of the “Gutegemeinschaft fur Stuckbeschichtung” (e.V)), in which powder-coated test sheet metal specimens are covered with filer paper wetted with water for a period of 4 hours at 60° C. and then a measurement made of any lightening of the coloration of the surface is measured, shows for example significant advantages for all of the powder paints which are made with the resin in accordance with the invention. In addition, there are quality features like flexibility of the paint layer (tested by the reverse impact test) and their resistance to rapid weathering (carried out with the UVB-313 fluorescent lamp in an accelerated weathering tester of the firm Q-Panel Co.) which demonstrate at least equal qualities with powder paints made by a manner other than that of the invention.

It is especially advantageous when, in accordance with the invention, pyrogenic silicic acid is admixed with the synthetic resin binder. According to the invention, the pyrogenic oxide can be surface treated. Preferably the mode according to a further feature of the invention is such that the primary particle sizes of the pyrogenic additive or additives is between 7 and 10 nm.

According to a further aspect of the invention, the pyrogenic additive or pyrogenic additives are added in an amount of 0.05 to 10%, preferably 0.25 to 2.5%, and especially 1% by weight of the synthetic resin binder. The amount of pyrogenic oxide used advantageously will depend among other things upon the type, the particle sizes and the chemical surface treatment of the pyrogenic additive.

The invention also embraces a powder paint comprised of a synthetic resin binder, additives and optionally pigments and fillers which are characterized in that the synthetic resin binder had admixed thereto pyrogenic oxides of silicon, aluminum or titanium or mixtures thereof with primary particle sizes between 5 and 65 nm. The invention also encompasses a coating or coat comprised of such powder paint.

The substance of the invention, without limiting the invention thereto will be exemplified by the following examples.

### COMPARATIVE EXAMPLE

### Carboxyl Group Containing Polyester Resin (Resin 1), not according to the Invention

In a 2 liter reaction vessel equipped with a stirrer blade, a temperature sensor, a partial reflux column, a distillation bridge and an inert gas feed tube (nitrogen), 552.05 g of 2,2-dimethylpropandiol 1,3 and 3.10 g of ethylene glycol are combined and with the addition of 20 g water and heating to a maximum of 140° C. under a nitrogen atmosphere is melted. Under stirring 702.77 g of terephthalic acid, and 0.1% with respect to the total amount of the finished resin of a tin containing catalyst, are added and the temperature of the reaction mass is increased in steps to 240° C. The reaction is carried out at this temperature until no further distillate is removed and the acid number of the hydroxy-functional polyester resin is less than 10 mg KOH/g polyester resin.

Then 207.68 g of isophthalic acid and 29.23 g of adipinic acid are added and the aesterification is carried out until the desired acid number (about 33) is reached with the reaction at the end being supported by the use of vacuum (about 100 m/bar). The finished Resin 1 was given the identifier: SZ 33,4, OHZ 3,4.

### EXAMPLE

### Carboxylic Group Containing Polyester (Resin 2) According to the invention

To the composition first reaction stage given above, comprised of the 2,2-dimethylpropandiol-1,3, ethyleneglycol, terephthalic acid and tin containing catalyst, 13.19 g Aerosil® 200 was added and the composition reacted analogously as previously to a hydroxy functional polyester resin.

Then in a manner analogous to the foregoing, isophthalic acid and adipinic acid was added and the aesterification carried out until the desired acid number (about 33) was reached. The finished Resin 2 was assigned the following identifier: SZ33,0, OHZ 3,7.

Using these polyester resins, previously ground to a particle size of less than 2 mm, the following green powder paint test compositions were prepared:

| | POWDER | POWDER | |
|---|---|---|---|
| | PAINT A | PAINT B | POWDER |
| RAW | NOT | NOT | PAINT |
| MATERIAL | INVENTION | INVENTION | INVENTION |
| Resin 1 | 380 | 380 | — |
| Resin 2 | — | — | 383.8 |
| Primid XL 552 | 20 | 20 | 20 |
| Byk 365 | 5 | 5 | 5 |
| Benzoin | 1 | 1 | 1 |
| Heucodur | 7.76 | 7.76 | 7.76 |
| Yellow G 9239 | | | |
| Bayferrox 130B | 1.23 | 1.23 | 1.23 |
| Heliogen | 8.44 | 8.44 | 8.44 |
| Green L 8731 | | | |
| Titan 2310 | 1.1 | 1.1 | 1.1 |
| Portaryte B 10 | 74.5 | 74.5 | 74.5 |
| Aerosil 200 | — | 3.8 | — |

The raw materials of the individual formulations are intimately premixed and then extruded through an extruder of the type Prism TSC 16 PC, screw length=24×screw diameter (heating in the hot zones in the direction of the material flow: 110° C., 120° C., and 130° C., speed 400 RPM). The cooled extrudate was broken up and milled in a sifting mill with the grain size above 100 μm removed. Then the powder paint was applied in a layer thickness of 80 μm (finished paint film) to chromate treated aluminum sheet of a thickness of 0.7 mm and baked in for 10 minutes at 200° C. in a circulating furnace.

Evaluation of the powder coating, visual:

| | |
|---|---|
| POWDER PAINT A | Numerous craters, very good shine, |
| (NOT INVENTION) | flow coverage 7 under PCT-Standard |
| POWDER PAINT B | Hardly any craters, slight crinkling |
| (NOT INVENTION) | (reduced shine) flow coverage 6 in |
| | accordance with PCT-Standard |
| POWDER PAINT | No craters, very good shine, flow or |
| INVENTION | coverage 8 under PCT-Standard |

Evaluation of the powder coatings, technological (water spot test):

| | |
|---|---|
| POWDER PAINT A | Noticeable lightening |
| (NOT INVENTION) | |
| POWDER PAINT B | Noticeable lightening but slightly |
| (NOT INVENTION) | less than powder paint A |
| POWDER PAINT | Practically no noticeable lightening |
| INVENTION | |

The powder paint C with Resin 2 powder paint (according to the invention) was clearly superior to the powder paint A and B with Resin 1 which demonstrated the technological value of the invention.

1. A synthetic resin binder for producing powder paints, characterized in that it is admixed with pyrogenic oxides of silicon, aluminum or titanium or mixtures thereof with primary particle sizes between 5 and 65 nm.

2. The synthetic resin binder according to claim 1, characterized in that it is admixed with pyrogenic silicic acid.

3. The synthetic resin binder according to claim 1, characterized in that the pyrogenic oxides are surface treated.

4. The synthetic resin binder according to claim 1, characterized in that the primary particle size of the pyrogenic additive or additives is between 7 and 40 nm.

5. The synthetic resin binder according to claim 1, characterized in that the pyrogenic additive or additives re added in an amount of 0.05 to 10% with respect to the weight of the synthetic resin binder.

6. The synthetic resin binder according to claim 5, characterized in that the pyrogenic additive or pyrogenic additives are contained in an amount of 0.25 to 2.5%, preferably 1% with respect to the weight of the synthetic resin binder.

7. A powder paint comprised of a synthetic resin binder, additives and optionally pigments and fillers, characterized in that the synthetic resin binder had mixed therewith pyrogenic oxides of silicon, aluminum or titanium or mixtures thereof with primary particle sizes between 5 and 65 nm.

8. A coat or coating comprised of a powder paint according to claim 7.
